(19) United States
(12) Patent Application Publication
(10) Pub. No.: US 2004/0256304 A1
(43) Pub. Date: Dec. 23, 2004

(54) Recirculating filter

(76) Inventor: Carlos V. Perry JR., Gainesville, VA (US)

Correspondence Address: MCGUIREWOODS, LLP, 1750 TYSONS BLVD, SUITE 1800, MCLEAN, VA, 22102, US

(21) Appl. No.: 10/892,323

(22) Filed: Jul. 16, 2004

Related U.S. Application Data
(63) Continuation-in-part of application No. 10/776,282, filed on Feb. 12, 2004.
Application No. 10/776,282 is a continuation of application No. 09/764,294, filed on Jan. 19, 2001, now Pat. No. 6,767,457.

(51) Int. Cl. B01D 24/12; B01D 24/14; C02F 9/00

(52) U.S. Cl. 210/284; 210/291; 210/196; 210/532.2

(57) ABSTRACT

A self contained filter for a recirculating tank is used in a septic system. The self contained filter is a mattress-like filter made of woven material encapsulating aggregate material therein. The weave of the mattress-like woven material is smaller than the aggregate material. In another aspect, at least one mattress-like filter is placed within a tank.

### CROSS REFERENCE TO RELATED APPLICATIONS

This application is a continuation-in-part application of U.S. application Ser. No. 10/776,282, which is a continuation application of U.S. application Ser. No. 09/764,294, filed on Jan. 19, 2001, which are incorporated by reference in their entirety.

### BACKGROUND OF THE INVENTION

1. Field of the Invention

The present invention generally relates to a filter for a recirculating tank and, more particularly, to a self contained filter for a recirculating tank used in a septic system.

2. Background Description

Septic systems are widely used for a variety of applications ranging from single family homes to industrial applications. These systems also vary greatly in design; namely, aerobic and anaerobic type systems. In either type of septic systems, the main objective is to treat wastewater in the most efficient manner in order to ensure that the water is properly filtered for distribution within a drain field or other distribution system.

In certain types of septic systems, a sand filter is used to filtrate the wastewater prior to further treating or distribution of the effluent. The sand filter is disposed within a recirculating tank and includes several layers of varying sized aggregate. For simplicity of discussion, the aggregate is manually disposed within the tank, with the larger sized aggregate on the bottom of tank and the smaller or finer sized aggregates progressively being layered toward the top of the tank. In some systems, one sized aggregate may be used to filter the wastewater; although, it is preferable to use at least two or more layered sand filter for more efficient filtering.

In operation, wastewater flows into the top of the tank. The wastewater is then filtered through the several layers of the aggregate until the wastewater reaches the bottom of the tank. At the bottom of the tank, the filtered wastewater is then discharged to other portions of the septic system. As is known in the art, the different sized aggregates will filter different sized materials from the wastewater.

Aggregate has been used to treat effluent for over 50 years. However, due to the aggregate widely used, high failure rates and high maintenance costs are common. The common causes of failure and maintenance of systems utilizing such aggregate is: i) migration of sand; ii) compaction; and iii) channeling of the sand. These common problems are due to many factors such as the high specific gravity of the aggregate which decreases the efficiency of the aggregate filter and thus the cleaning of wastewater.

For example, migration occurs when the top or finer layers of aggregate have a tendency to migrate into the more course layers of aggregate. This migration affects the filtering properties of the system, and leads to the need to completely remove and replace all of the aggregate from the tank. This is a time consuming and costly procedure.

Compaction of the aggregates also occurs within these systems. Compaction results in puddling of the wastewater at the top of the tank due to lack of air spaces within the several layers of the aggregate. Much like migration, the aggregate within the tank must be replaced in order to correct the compaction of the aggregate. Also, heavy sand and other currently used aggregate compacts rapidly when repeatedly wetted, thus reducing the available space for air and the filter's efficiency and effectiveness. As such, sand filters require the surface of the sand to be “fluffed” up each year or replaced, thus increasing maintenance and cost. This may be accomplished via deep raking or other suitable means to loosen the compacted sand. It is also noted that the U.S. Environmental Protection Agency (EPA) manual of maintenance guidelines for on-site wastewater systems recommends that sand filter surfaces be loosened yearly to prevent compaction problems. Finally, channeling occurs in these types of sand filters; that is, a channel or tunnel will be formed through all of the aggregate layers. This leads to poor filtering of the wastewater and the need, again, to replace all of the aggregate within the tank.

The present invention is adapted to solving these and other problems.

### SUMMARY OF THE INVENTION

The invention is directed to providing an efficient recirculating sand filter tank used in a septic system by prevent migration, compaction and/or channeling, for example, aggregate material. The invention is further directed to a filter which is easy to install within a recirculating sand filter tank.

In order to provide the above advantages, the present invention includes a mattress of woven material encapsulating aggregate material therein. The weave of the mattress woven material is smaller than the aggregate material. In another aspect of the present invention, at least one mattress filter is placed within a tank. The aggregate has a specific gravity which provides the benefits, as discussed below.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows a side view of a filter of the present invention;

FIG. 2 shows a cut-away view of the filter in a recirculating tank;

FIG. 3 shows a cut-away view of several filters in a recirculating tank;

FIG. 4 shows a top view of the filter and recirculating tank;

FIG. 5 shows a top view of an embodiment of the recirculating tank of the present invention;

FIG. 6 shows a left end view of an embodiment of the recirculating tank of the present invention; and

FIG. 7 shows a side view of an embodiment of the recirculating tank of the present invention.

### DETAILED DESCRIPTION OF A PREFERRED EMBODIMENT OF THE INVENTION

The invention is directed to a recirculating sand filter for a septic system. The recirculating sand filter is a mattress-like filter having aggregate and/or sand completely encapsulated therein. The mattress-like filter preferably contains synthetic aggregate material (e.g., particles) disposed therein, such as synthetic sand, but may equally contain natural sand and/or other gravel products. For purposes of the present discussion, synthetic particles will be discussed herein; however, it should be understood by those of ordinary skill in the art that the present invention is equally adaptable for use with natural aggregate material.

In the embodiments of the present invention, the synthetic particles will vary in size for each mattress-like filter. The mattress-like filter will be individually sealed once the synthetic particles are placed therein. These individually sealed mattress-like filters are then placed within a tank with the largest aggregate filled mattress-like filter preferably located near the bottom of the tank and the finest aggregate filled mattress-like filters located towards the top of the tank. The mattress-like filter of the subject invention includes several advantages; namely, the filter prevents migration and compaction of the particulate matter as well as prevents the channeling phenomenon. The present invention also is easy to transport and install within a septic system.

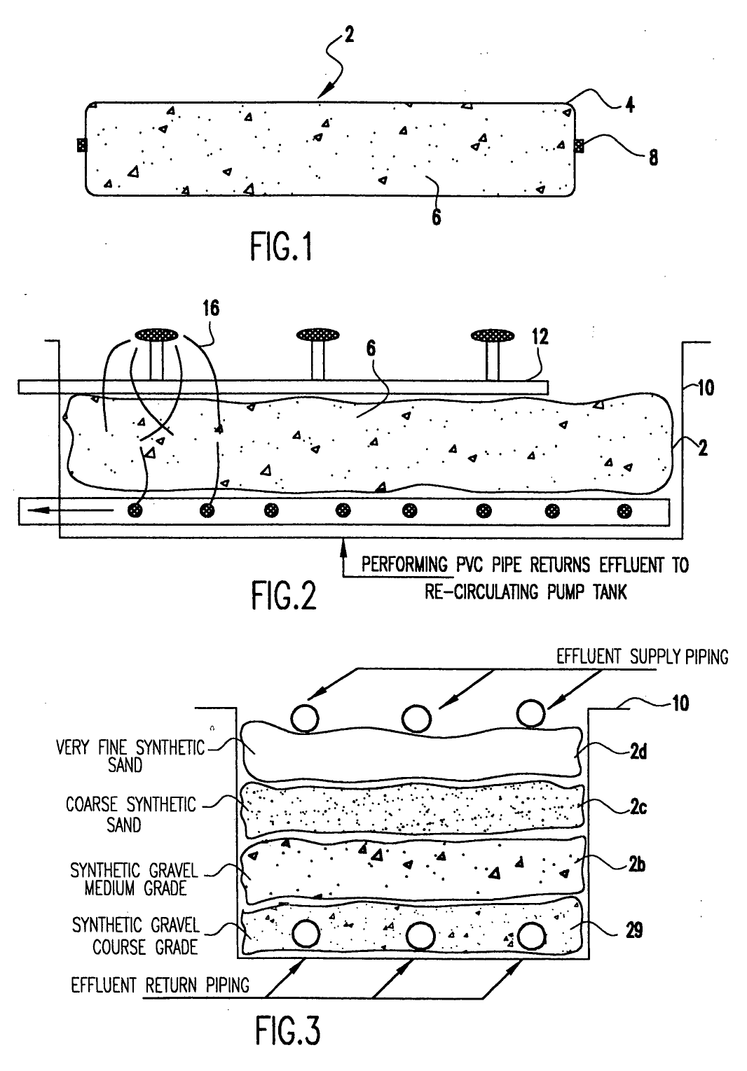

Referring now to the drawings, and more particularly to FIG. 1, there is shown a side view of a mattress filter of the present invention. The mattress filter is generally depicted as reference numeral 2, and includes a woven fabric 4 or synthetic cloth. Synthetic aggregate material (e.g., particles) 6 is disposed within the woven cloth 4 and is preferably completed encapsulated therein. That is, the woven cloth 4 is sealed using any conventional method after the synthetic particles 6 are placed therein. In the preferred embodiments, only one sized particle 6 is placed within each individual mattress filter 2. The weave of the woven cloth 4 is smaller than the synthetic particles 6 placed therein so as to ensure that the synthetic particles 6 remain within the mattress filter 2. This prevents migration of the synthetic particles. A handle 8 may be placed on or integrally woven to sides of the mattress 2.

Still referring to FIG. 1, the synthetic cloth 4 is preferably propylene and/or ethylene clothing. It should be understood, though, that other materials, natural and/or synthetic, may also be used with the present invention. The synthetic particles 6 are preferably propylene, polyvinylchloride and/or other such material. The specific gravity of the synthetic particles 6 should, in embodiments, be within the range of approximately 0.05 to 0.96. The specific gravity can preferably range between approximately 0.05 to 0.5 and more preferably approximately 0.05 to 0.25. In one preferred embodiment, the specific gravity should be less than 0.90. This prevents the compaction of the synthetic particles 6 due to the fact that at such specific gravity the synthetic particles 6 will have a tendency to float. The sizes of the synthetic particles 6 will depend on the specific application of use, but may range in size from 0.05 mm to 1½ inches diameter or more. The thickness of the mattress 2 will also vary depending on the specific application of use, but is preferably approximately six inches thick.

The following table is representative of extensive testing over a 12 month period to determine the optimal specific gravity of the aggregate to minimize migration, compaction, and channeling. Biochemical oxygen demand (BOD) was the most widely used procedure, which measures the amount of dissolved oxygen used by microorganisms in the oxidation of organic matter in sewage. Total suspended solids (TSS) is a measure of the organic and inorganic solids that remain in wastewater after separation occurs in the septic tank. TSS is typically measured in mg/L and may range from, for example, 5 mg/L to 30 mg/L.

In particular, the extensive experimentation included performing tests on four tanks similar to those described in FIGS. 1-7 with a 5 day BOD procedure utilizing varying specific gravities of synthetic particles. The 5 day BOD test was preformed using the dilution method with HACH test equipment Method 8043 as described in HACH Water Analysis Handbook, which is incorporated herein by reference in its entirety. The 5 day BOD procedure is the EPA excepted standard for measuring BOD in wastewater.

In testing, the tanks were filled with varying specific gravities of aggregate material, such as synthetic media. Each media had approximately the same size and shape with different specific gravities ranging from approximately 0.96 to 0.05 specific gravity. Each tank was dosed daily with a same amount of septic effluent from a large holding tank. The discharge from each filter was collected and tested for BOD levels weekly. The results have been converted to monthly averages as shown in Table 1.

TABLE 1*

| | Specific | Specific | Specific | Specific |
|---|---|---|---|---|
| | Gravity | Gravity | Gravity | Gravity |
| | 0.05 | 0.25 | 0.50 | 0.96 |
| Month 1 | 12.7 mg/L | 12.8 mg/L | 12.6 mg/L | 12.7 mg/L |
| Month 2 | 12.2 mg/L | 12.4 mg/L | 12.5 mg/L | 12.3 mg/L |
| Month 3 | 12.6 mg/L | 12.5 mg/L | 12.7 mg/L | 12.8 mg/L |
| Month 4 | 12.1 mg/L | 12.7 mg/L | 13.2 mg/L | 14.1 mg/L |
| Month 5 | 12.2 mg/L | 12.8 mg/L | 13.0 mg/L | 14.8 mg/L |
| Month 6 | 12.0 mg/L | 12.9 mg/L | 13.6 mg/L | 14.5 mg/L |
| Month 7 | 12.1 mg/L | 12.8 mg/L | 13.5 mg/L | 14.9 mg/L |
| Month 8 | 12.0 mg/L | 13.2 mg/L | 13.8 mg/L | 15.6 mg/L |
| Month 9 | 11.9 mg/L | 13.6 mg/L | 14.1 mg/L | 17.1 mg/L |
| Month 10 | 11.9 mg/L | 13.5 mg/L | 14.6 mg/L | 17.7 mg/L |
| Month 11 | 12.0 mg/L | 13.9 mg/L | 15.1 mg/L | 17.5 mg/L |
| Month 12 | 12.0 mg/L | 14.1 mg/L | 15.4 mg/L | 17.9 mg/L |

*BOD Values expressed are plus or minus 1%

As illustrated in Table 1, as the specific gravity increased (e.g., heavier media) the BOD increased. That is, as the media compacts over time with repeated wetting void spaces are compressed more tightly. Accordingly, there is less void space for air, thus less air is absorbed by the effluent resulting in an increased BOD. Accordingly, a more efficient system including less migration, compaction and channeling occurs as the specific gravity of the aggregate lowers. In specific, it is seen that better results are provided at lower specific gravity of the materials.

The materials may be styrene, ethylene or propylene, for example. Also, in order to make these materials lighter, it is possible to expand the material by injecting an inert gas while the plastic is in a molten state. The more gas that is injected into the molten plastic the lighter the finished product.

FIG. 2 shows a cut-away view of the mattress filter 2 placed within a recirculating tank 10. An effluent piping system 12 is located at the top of the tank 10 and a perforated PVC return pipe 14 is located at the bottom of the tank 10 (below the mattress filter 2). Effluent 16 flows into the tank 10 via the effluent piping system 12. The effluent 16 then flows through the woven cloth 4 of the mattress filter 2 and is filtered by the synthetic particles 6. The effluent, after being filtered, will then flow to the bottom of the tank 10 and into the return piping 14. In the embodiments, the mattress filter 2 will substantially fill the tank 10.

FIG. 3 shows a cut-away view of several mattress filters placed within the tank 10. As seen in this figure, the course synthetic particles are placed in mattress filter 2a at the bottom of the tank 10 and progressively finer materials are placed in the mattress filters 2b-2d, respectively. This provides for proper and most efficient filtration of the effluent. It should be recognized that the present invention is not limited to the arrangement shown in FIG. 3, and that other sized particles and combinations of mattress filters may also be disposed within the tank 10.

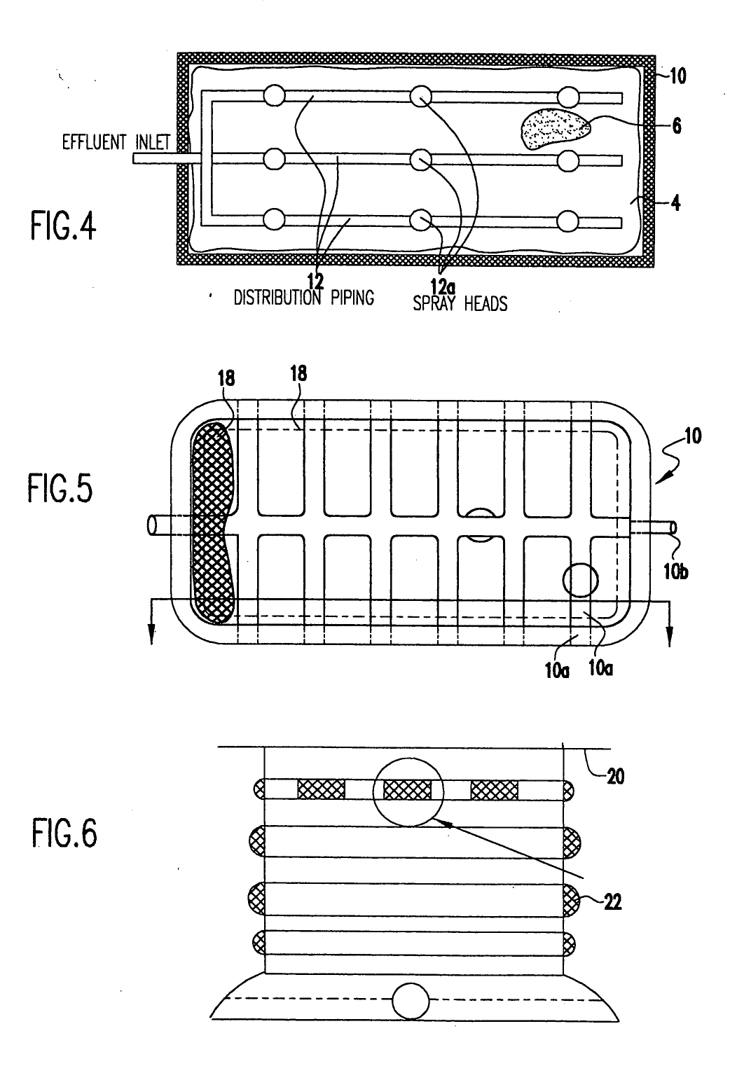

FIG. 4 shows a top view of the mattress filter 2 and recirculating tank 10. In this view, spray heads 12a are shown extending from the effluent piping system 12. The spray heads 12a are used to distribute the effluent throughout the mattress filter 2 in an even distribution pattern.

FIG. 5 shows a top view of an embodiment of the recirculating tank 10. In this embodiment, the tank 10 includes troughs 10a integrally formed in the bottom and sides of the tank 10. The troughs 10a replace the piping 12 and 14 of the embodiment shown in FIGS. 2-4. The tank 10 may be either precast concrete or a synthetic material such as plastic, PVC or other suitable material. An inlet pipe 10b may extend from the interior to an exterior of the tank 10. A sheet 18 of plastic, PVC or other suitable material may be placed on either the bottom or the sides of the tank 10. If the sheet 18 is placed on the bottom of the tank 10, perforations are preferably placed within the sheet so that effluent can flow from the mattress filter 2 to the integral troughs 10a.

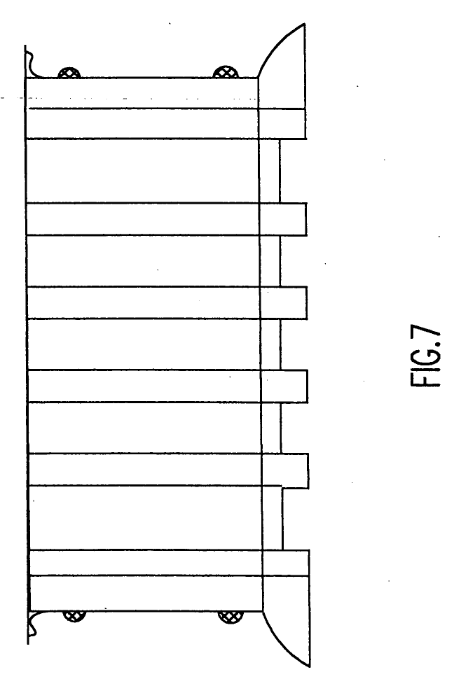

FIG. 6 shows a left end view and FIG. 7 shows a side view of the recirculating tank of the embodiment of FIG. 5. In these views, a flange 20 and ribs 22 are shown as part of the integral construction of the tank 10.

While the invention has been described in terms of preferred embodiments, those skilled in the art will recognize that the invention can be practiced with modification within the spirit and scope of the appended claims.

Having thus described our invention, what we claim as new and desire to secure by letters patent is as follows:

1. A filter for use in a recirculating tank, comprising:
aggregate material, wherein a specific gravity of aggregate material is less than 0.90; and
a mattress of woven material encapsulating the aggregate material, a weave of the mattress of woven material being smaller than the aggregate material thereby preventing migration of the aggregate material.

2. The filter of claim 1, wherein the aggregate material comprises synthetic particles.

3. The filter of claim 2, wherein the synthetic particles comprises at least one of propylene and polyvinylchloride and styrene.

4. The filter of claim 2, wherein the synthetic particles include a specific gravity of approximately 0.05 to approximately 0.50.

5. The filter of claim 4, wherein the synthetic particles prevent compaction of the filter.

6. The filter of claim 1, wherein the aggregate material ranges in diameter from 0.05 mm to 1½ inches diameter.

7. The filter of claim 1, wherein the woven material is fabric or a synthetic material.

8. The filter of claim 7, wherein the synthetic material propylene or ethylene clothing.

9. The filter of claim 1, wherein the aggregate has a specific gravity ranging between approximately 0.05 to 0.5.

10. A filter system adapted for use in a septic system, comprising at least one filter placed within a tank, the filter having aggregate material sealed therein which has a specific gravity of less than approximately 0.90.

11. The recirculating filter system of claim 10, wherein the at least one filter comprises at least two filters.

12. The recirculating filter system of claim 11, wherein each of the at least two filters are have a different sized aggregate sealed therein.

13. The recirculating filter system of claim 12, wherein a smaller sized aggregate filled filter is arranged over a larger sized aggregate filled filter.

14. The recirculating filter system of claim 10, wherein the aggregate material comprises synthetic particles.

15. The recirculating filter system of claim 14, wherein the synthetic particles comprise at least one of propylene and polyvinylchloride and styrene.

16. The recirculating filter system of claim 14, wherein the synthetic particles have a specific gravity of approximately ranging between 0.05 to 0.50.

17. The recirculating filter system of claim 10, wherein the filter is made from one of fabric and a synthetic material.

18. The recirculating filter system of claim 17, wherein the synthetic material comprises at least one of propylene and ethylene clothing.

19. The recirculating filter system of claim 18, wherein the cover comprises a weave of the at least one of fabric and the synthetic material or any combination thereof that has a smaller diameter than the diameter of aggregate material .

20. The filter of claim 10, wherein the aggregate has a specific gravity ranging between approximately 0.05 to 0.25.
